(19) United States
(12) Patent Application Publication
(10) Pub. No.: US 2024/0359917 A1
(43) Pub. Date: Oct. 31, 2024

(54) STORAGE SYSTEM WITH A MULTI-LEVEL STORAGE RACK, A VERTICAL LIFT CONNECTING THE LEVELS OF THE MULTI-LEVEL STORAGE RACK AND METHOD OF OPERATION

(71) Applicant: Dematic GmbH, Heusenstamm (DE)

(72) Inventor: Shin Yamashita, Oberursel (DE)

(21) Appl. No.: 18/575,536

(22) PCT Filed: Jun. 30, 2022
(86) PCT No.: PCT/EP2022/068175

§ 371 Date: Dec. 29, 2023

(30) Foreign Application Priority Data
Jul. 9, 2021 (EP) 21184872.6

(51) Int. Cl. B65G 1/06

(52) U.S. Cl. CPC B65G 1/06

(57) ABSTRACT

A storage system with a multi-level storage rack, a vertical lift connecting the levels of the multi-level storage rack, the vertical lift having a conveyor platform, at least one rack level has a conveyor adjacent to the vertical lift, and a controller configured for controlling the lift, conveyor platform and conveyor such that the lift conveyor platform or conveyor are controlled to transfer a load between the lift conveyor platform and the rack conveyor or vice versa. The transfer is controlled to be performed as soon as the lift conveyor platform and the rack conveyor are at same height and the lifting platform over travels beyond the transition level allowing the transfer to be initiated earlier by transferring the load from the higher lift conveyor platform to the lower rack conveyor or vice versa.

### CROSS REFERENCE TO RELATED APPLICATION

The present application claims the priority benefits of International Patent Application No. PCT/EP2022/068175, filed Jun. 30, 2022, and claims benefit of European patent application no. EP21184872.6, filed on Jul. 9, 2021.

### BACKGROUND AND FIELD OF THE INVENTION

Storage systems with a vertical lift connecting levels of a multi-level storage rack, wherein the vertical lift has a conveyor platform and each rack level has a buffer conveyor adjacent to the vertical lift and a controller configured for controlling the lift, a conveyor platform and rack conveyor such that the lift conveyor platform or rack conveyor are controlled to transfer a load between the lift conveyor platform and the rack conveyor or vice versa, are known. Loads are transferred between storage spaces in the racks and the buffer conveyors by storage and retrieval vehicles. Such systems are usually referred to as shuttle storage systems and for example known from the applicant: https://www.dematic.com/de-de/produktueberblick/lagertechnik/multishuttle.

In such shuttle systems the vertical lift throughput performance has been one of the most critical parts of the system design and is often seen as a bottle neck, as there are many shuttles serving a lift.

Increasing speed and acceleration and/or deceleration of vertical lift and transfer operation is the easiest way to realize an increase in throughput. However, this also tends to compromise hardware cost, the system reliability and stability and increase energy consumption.

Additionally, the vertical lift speed is limited, especially on the downward movement by the items losing contact to the lift, if the acceleration is too high.

US 2016/264356 A1 discloses that in a lift carrier device, a controller causes a first longitudinal drive device and a second longitudinal drive device respectively to be lifted or lowered by a first lift drive device and a second lift drive device, to cause a first article stage and a second article stage to pass by each other in a state where the first article stage and the second article stage have been moved by the first longitudinal drive device and the second longitudinal drive device to positions where the first article stage and the second article stage do not longitudinally overlap each other in plan view.

### SUMMARY OF THE INVENTION

The object of the present invention is to provide increased vertical lift performance without increase in lift dynamics and compromising the system reliability or stability.

In accordance with an embodiment of the invention, a storage system is provided with a multi-level storage rack, a vertical lift connecting the levels of the multi-level storage rack, the vertical lift having a conveyor platform, at least one rack level having a driven rack conveyor adjacent to the vertical lift, and a controller configured for controlling the lift, the conveyor platform having a driven conveying means controlled by the controller to transfer loads to and from the conveyor platform and the rack conveyor such that the lift conveyor platform and rack conveyor are controlled to transfer a load between the lift conveyor platform and the rack conveyor or vice versa, the lift having a sensor arranged to determine a height positioning of the lift platform verses the rack level and coupled with the controller, wherein the transfer is controlled by the controller to be performed as soon as the lift conveyor platform and the rack conveyor are at same height based on height positioning from the sensor and the controller controlling the lifting platform to travel vertically beyond the rack level for transition, thus allowing the transfer to be initiated by the controller earlier by transferring the load from the higher lift conveyor platform to the lower rack conveyor or vice versa by the controller controlling the driven conveying means of the conveyor platform and the conveyor adjacent to the vertical lift.

The vertical lift is intended to be made ready for transferring a load as early as possible. A load transfer can only be initiated after the lift conveyor platform has arrived on a specific level and has settled at the transfer level, i. e. leveling with the adjacent conveyer, so as to prevent a load from collision with either the lift conveyor platform or the buffer conveyor. Normally leveling is performed with a tolerance of no more than 3 mm to prevent collision. However, in order to accomplish this, the vertical lift needs to go through a positioning process consisting of certain slow creeping movement towards the transfer level and settling time for lifting carriage bouncing, swinging or vibration, both of which take time. Moreover, settling time is increased if the vertical lift has a long vertical length (height) as frequency of bouncing, swinging gets lower with increasing height.

The inventor has realized that it is possible to minimize or omit the slow and time consuming creeping and settling process by means of over traveling of the lifting carriage beyond the transfer level. In other words, and according to an aspect of the invention, the transfer is controlled to be performed before the lift conveyor platform and the rack conveyor are at same height by transferring the load from the higher lift conveyor platform to the lower rack conveyor or vice versa. There is no need to wait for the finishing of the levelling process. This so-called “waterfall” allows load transfer to be performed before the lift carriage has leveled and does not require settling time for stop of lifting carriage bouncing, swinging or vibration.

Lower or higher in this sense means that the lift carriage or conveyor platform overruns the exact level by no more than 30 mm, preferably 25 mm, most preferred 20 mm. This allows the transfer of the load to start with the load having the risk of toppling. Same height means at same level concerning the conveyor surfaces with a tolerance of maximum 5 mm, preferably 3 mm.

The controller therefore controls the transfer of the loads to and from the conveyor lift platform and rack conveyor by controlling their respective driven conveyors and drives. This happens based on the sensor input from the lift sensor indicating the height positioning and optionally also the direction of travel (upwards vs. downwards).

In a preferred embodiment each (every) storage level has a rack conveyor adjacent to the vertical lift controlled by the controller to function as a buffer decoupling the lift or to function as a supply and discharge conveyor for the storage rack. It is also possible to have at, at least one rack level storage, a rack conveyor adjacent to the vertical lift on each side functioning as buffer. In other words, there are two opposite conveyors sandwiching the vertical lift on such a level.

In a preferred embodiment each (every) storage level has a rack conveyor adjacent to the vertical lift on each side. Then it is beneficial that the controller is configured for controlling the lift, the driven conveying means of the conveyor platform and the drive of the driven rack conveyor such that the lift conveyor platform and conveyor are controlled to transfer a load between the lift conveyor platform and the rack conveyor or vice versa simultaneously. Such conveyors can be buffer conveyors as stated above or also discharge or supply conveyors for discharging or supplying goods from or to a lift, e. g. in a storage rack, or combinations of such. The rack conveyors are beneficially arranged within the footprint of the rack adjacent the lift which would also be in line with the extension of the rack so as to allow better access and use of space.

In case of such a tandem cycling vertical lift, i. e. pick up on one side and drop-off on the opposite side when a conveyor is present on each side of the vertical lift on a level, the overrun can be realized by tilting the lifting carriage so that one side can be over traveled while the opposite side is aligned with opposite conveyor. So the vertical lift conveyor platform which is either statically tilted or dynamically tilted by a tilting mechanism (e.g. one-sided pneumatic lifter or scissor lift mechanism) from a horizontal plane, such that that one side can be over travelled (vertically positioned beyond the rack level for transition, i.e. above or below) while the opposite side is aligned with the opposing conveyor of the rack level for transition. In other words, the vertical lift conveyor platform is tilted from a horizontal plane, such that at one side the lift platform can be only coarsely positioned (i. e. not aligned and below or above depending on travel direction and pickup or drop-off direction) while at the opposite side the conveyor platform is aligned with opposite conveyor. Tilting may be fixed depending on conveying direction of the adjacent conveyors also being monodirectional.

Alternatively, the vertical lift conveyor platform is horizontally oriented (not tilted but levelled) and the opposing rack conveyors are on different heights, i. e. achieving a vertically staggered “stepped” arrangement. Accordingly, it is also possible to have the rack conveyors at differing heights and the lift conveyor platform horizontal to achieve the same effect.

In one preferred embodiment, the storage system according to aspects of the invention is implemented in a shuttle system, i. e. in a system comprising at least two parallel racks with an aisle in between and at least a single level rack servicing vehicle running the length of the aisle on tracks between storage positions and the conveyor adjacent to the vertical lift. In particular a shuttle may be provided in each level serving only that level. It is however also possible to have the shuttles performing a so-called roaming function, i. e. change aisle levels using a shuttle lift, when less shuttles are present than levels. This allows the system to be less performant but less costly.

It is possible to initiate the transfer of a load before the lift platform arrives at the transit level and as soon as it reaches the transition level to increase the speed of the transfer to a higher or full speed, i. e. by controlling the conveyor speeds in dependence of the vertical position of the lift platform. The lift conveyor platform may be controlled to slowly move in the opposite direction to the initial vertical direction of movement to the rack level of transition (“creep back”) after the over travel beyond the transition rack level.

The present invention thus provides that loss of time is prevented by selectively performing over travel of the lifting carriage depending on lifting direction and load transfer direction. If not desired or not needed, e. g. for a high-speed transfer using belt conveyors etc., the lift platform may be controlled to travel backwards to transfer level while load unit transfer is already started but before load unit is touching the opposing conveyor surface, to align the lift platform and the conveyor(s) in order to smoothen the transition.

This leveling function should only be needed if, (i) the lift is approaching the transition level from above when a transfer is performed from stationary conveyor to lift conveyor, or (ii) the lift is approaching the transition level from below when transfer is performed from lift conveyor to stationary conveyor.

Further details of the invention will now be explained with reference to the figures.

### BRIEF DESCRIPTION OF THE DRAWINGS

FIG. 1 shows a perspective view of a first embodiment of a storage having a lift per rack with one conveyor on the same level;

FIG. 2 shows a perspective view of a second embodiment of a storage having a lift in the foot print of each rack of an aisle and both having buffer conveyors on each side;

FIG. 3 shows a top view of FIG. 2;

FIG. 4 schematically shows different versions of control of over run of the lift platform of the lifts;

FIG. 5 schematically shows different versions of control of tilting the lift platform of the lifts when performing transfer of loads from and to the lift platform; and

FIG. 6 schematically shows different versions of control of the lift platform of the lifts when performing transfer of loads from and to the lift platform with different height buffer conveyors.

### DESCRIPTION OF THE PREFERRED EMBODIMENTS

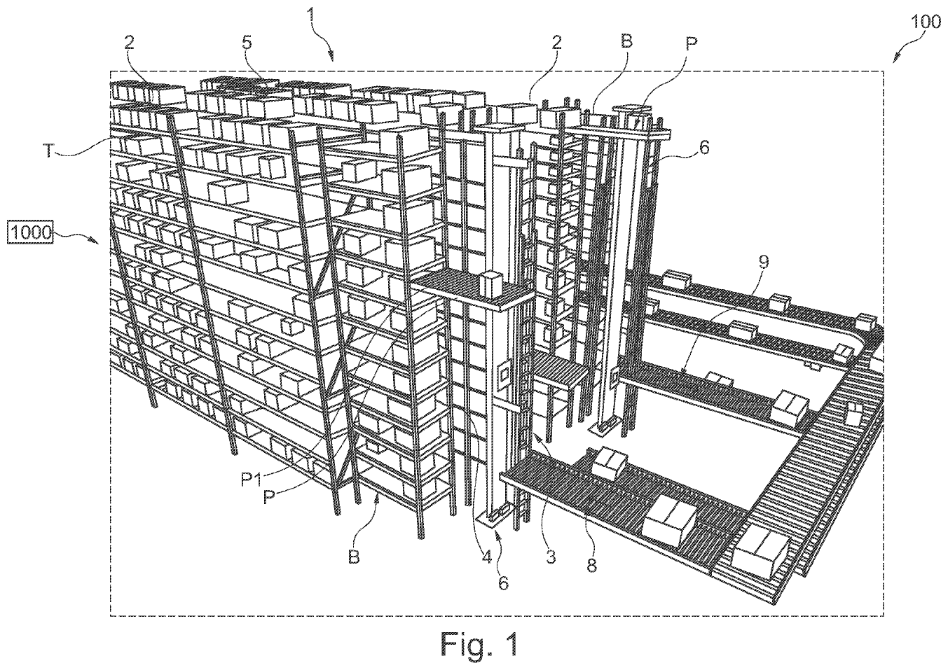

In FIG. 1 a first embodiment of a rack storage system referenced as 100 is shown. It comprises a storage 1 with at least two multi-level longitudinally extending storage racks 2 that are laterally separated by an aisle 3. In the figure only two such aisles 3 with corresponding double deep storage racks 2 are detailed, even though it is understood that multiple such racks and aisles may be present.

In each level guide tracks 4 for shuttles 5 extend the length of the aisle 3 and past at least two lifts 6, having a liftable and lowerable lift platform P for lifting or lowering load units T, which are trays in the present embodiment, but can obviously be any kind of package or container, box, tote etc. The lift platform P has an integrated conveyor, e. g. a roller conveyor or belt conveyor. The guide tracks 4 are arranged in each such level in a way that the shuttles 5 may fully access the storage racks 2 and each lift 6 by arranging the guide tracks 4 to extend along the aisle 3 and past the lifts 6. The shuttles 5 are designed to transfer the trays between the storage locations in the storage racks 2 and the lifts 6. To decouple this exchange buffer conveyors B are arranged on one side of each lift 6, allowing for an exchange or transfer in a single cycle manner.

The other side of each lift 6 is connected to a conveyor 8, 9 for transporting storage units to and from said lifts 6 (see arrows). The lifts 6 are arranged in a row in extension of the longitudinal extension of the storage rack 2 at the same front end of the storage.

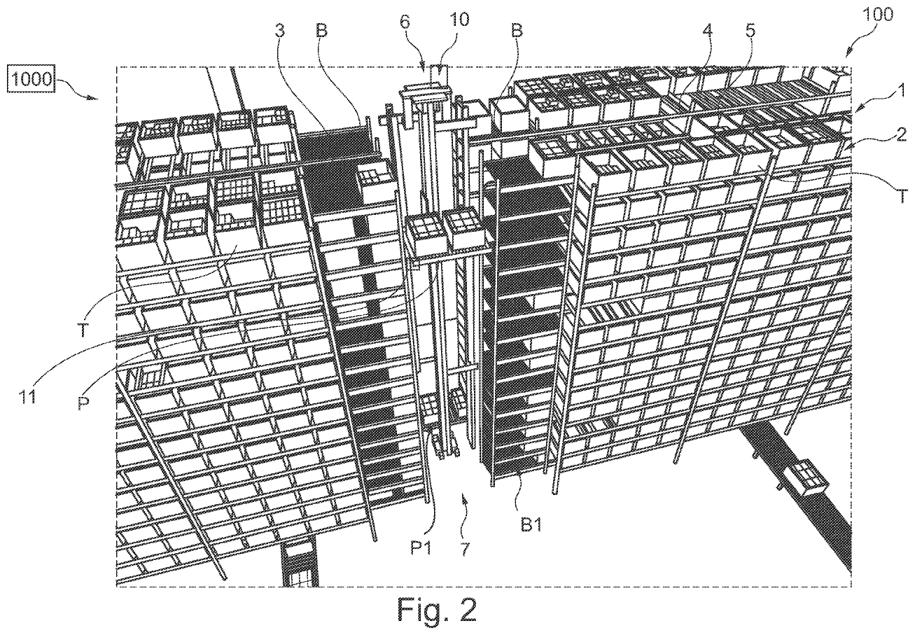

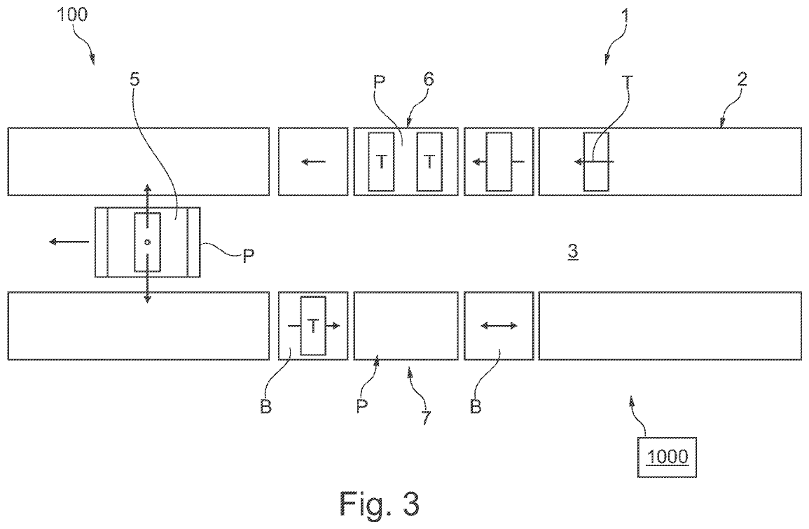

Similarly, in FIGS. 2 and 3 a top view of a second embodiment of a storage 100 in a storage level having a lift 6, 7 in the foot print of each rack 2 of an aisle 3 and both having buffer conveyors B on each side is shown, such that a shuttle 5 may pass the lifts 6, 7 and move along the whole aisle 3 to access each buffer conveyor B irrespective of location and all storage places in the racks 2. Having buffer conveyors B on each side of the lift 6 allows for an exchange or transfer in a dual cycle manner, i. e. supply and discharge of units T to the lift and from the lift at the same time. The buffer conveyors B may be roller or belt conveyors and be either unidirectional or monodirectional depending on the necessary material flow of units T.

In all of the described systems above, a controller 1000 (depicted schematically) is used to control the lifts 6, 7 and conveyors as well as other functions. In the present case such control of functions includes the travel and alignment of the lift platform P and its lift platform conveyors when handling loads or units T. In all embodiments, controller 1000 therefore controls drive 10 of the lift based on input from the height sensor 11 of the lifts 6, 7. Additionally, control 1000 controls the driven roller conveyor P1 of the lift platform and driven roller conveyor B1 of the buffer conveyors B to effect a transfer loads to and from the conveyor platform P and the conveyor B such that the lift conveyor platform P and conveyor B are controlled to transfer a load between the lift conveyor platform and the rack conveyor or vice versa.

The transfer is controlled by the controller 1000 to be performed as soon as the lift conveyor platform P and the conveyor B are at same height based on height positioning from the sensor 11 and the controller 1000 controlling the lifting platform to travel vertically beyond the rack level for transition thus allowing the transfer to be initiated by the controller 1000 earlier by transferring the load from the higher lift conveyor platform P to the lower conveyor B or vice versa by the controller controlling 1000 the driven conveying means P1 of the conveyor platform and the conveyor B1 adjacent to the vertical lift 6, 7.

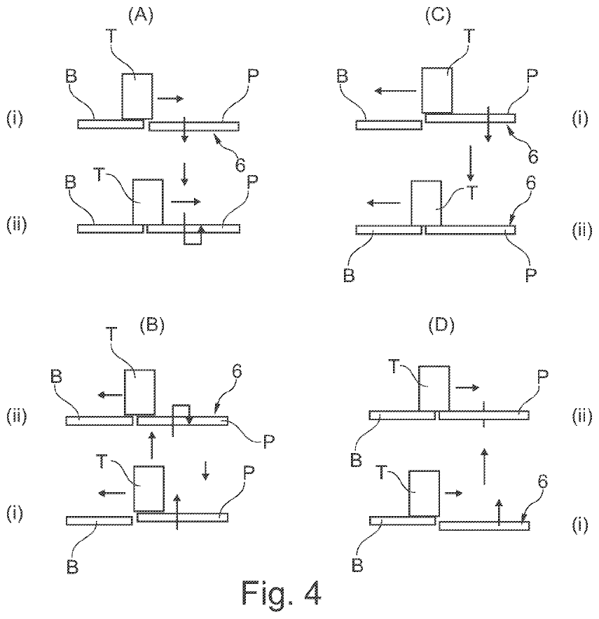

In FIG. 4A the transfer of a load unit T from a buffer conveyor onto a lift platform P of lift 6 is shown for the case that the lift platform must be lowered to be brought to the level of exchange.

In accordance with aspects of the present invention, the transfer is controlled to be performed as soon as the lift platform conveyor P and the rack conveyor B are at same height but lift platform over travels beyond the transition point then transferring the load unit T from the higher rack conveyor B to the lower lift platform conveyor P. This allows for the lift platform P to first (i) be quickly generally coarsely positioned overring the exchange level and the transfer to be initiated. Then (ii) the platform P can be exactly positioned slowly by creeping upwards while the transfer is taking place. This saves time.

In FIG. 4B the transfer of a load unit T from a lift platform P of lift 6 onto a buffer conveyor B is shown for the case that the lift platform must be raised to be brought to the level of exchange. In accordance with aspects of the invention, the transfer is controlled to be performed as soon as the lift platform conveyor P and the rack conveyor B are at same height but lift platform over travels beyond the transition point then transferring the load unit T from the higher lift platform conveyor P to the lower rack conveyor B. This allows for the lift platform P to first (i) be quickly generally coarsely positioned overring the exchange level and the transfer to be initiated. Then (ii) the platform P can be exactly positioned slowly by creeping downwards while the transfer is taking place. This saves time.

In FIG. 4C the transfer of a load unit T from a lift platform P of lift 6 onto a buffer conveyor B is shown for the case that the lift platform must be lowered to be brought to the level of exchange. In accordance with aspects of the invention the transfer is controlled to be performed before the lift platform conveyor P and the rack conveyor B are at same height by transferring the load unit T from the higher lift platform conveyor P to the lower rack conveyor B. This allows for the lift platform P to first (i) be quickly generally coarsely positioned above the exchange level and the transfer to be initiated. Then (ii) the platform P can be exactly positioned slowly by creeping downwards while the transfer is taking place. This saves time.

In FIG. 4D the transfer of a load unit T from a buffer conveyor B onto a lift platform P of lift 6 is shown for the case that the lift platform must be raised to be brought to the level of exchange. In accordance with aspects of the present invention the transfer is controlled to be performed before the lift platform conveyor P and the rack conveyor B are at same height by transferring the load unit T from the higher rack conveyor B to the lower lift platform conveyor P. This allows for the lift platform P to first (i) be quickly generally coarsely positioned below the exchange level and the transfer to be initiated. Then (ii) the platform P can be exactly positioned slowly by creeping upwards while the transfer is taking place. This saves time.

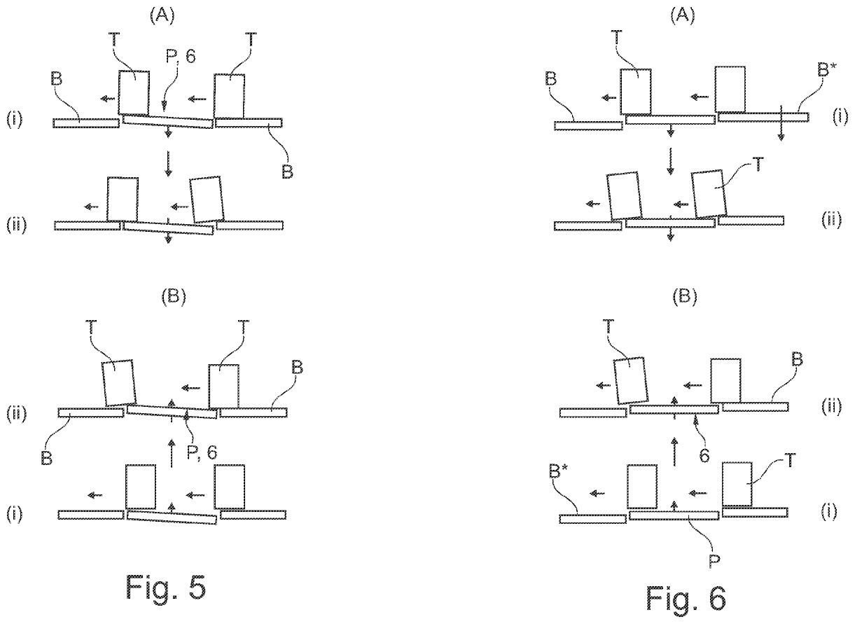

FIG. 5A schematically shows control of tilting the lift platform P of a lift 6 when performing transfer of load units T from the lift platform P to a buffer conveyor B on one side and vice versa on the other side, when the lift platform P must be lowered to the exchange level. In this case the lift platform P is tilted to be lower on the side of exchange from the buffer conveyor B to the lift platform P.

As depicted, this allows the lift platform P to over travel beyond the transition level on the right-hand side allowing an early transfer to be initiated whilst first (i) being quickly generally coarsely positioned above the exchange level on the left-hand side by lowering the platform and the transfer to be initiated. Then (ii) the platform P can be exactly positioned slowly by creeping further downwards while the transfer is taking place and finalized. This saves time. The lifting platform may then creep up to the level such that the waterfall of both sides become equal for smoother transition.

FIG. 5B schematically shows control of tilting the lift platform P of a lift 6 when performing transfer of load units T from the lift platform P to a buffer conveyor B on one side and vice versa on the other side, when the lift platform P must be raised to the exchange level. In this case the lift platform P is tilted to be lower on the side of exchange from the buffer conveyor B to the lift platform P.

As depicted, this allows the lift platform P to over travel beyond the transition level on the left-hand side allowing an early transfer to be initiated whilst first (i) being quickly generally coarsely positioned above the exchange level on the right-hand side by raising the platform and the transfer to be initiated. Then (ii) the platform P can be exactly positioned slowly by creeping further upwards while the transfer is taking place and finalized. This saves time. The lifting platform may then creep down to the level such that the waterfall of both sides become equal for smoother transition.

The tilting of the conveyor platform P from a horizontal levelled orientation to the tilted orientation can actively be performed by a scissor lift mechanism P2, that is controlled by controller 1000 to actively tilt the platform P as necessary based on lift travel direction, height sensor input and transfer details.

In the cases shown in FIGS. 4 and 5 the transfers of the units T may be initiated by allowing the units T to start the transfer from a higher source position to a lower goal position by overcoming a small step or height difference that is small enough such that the units T do not topple over.

As shown in FIGS. 6A and 6B a likewise effect can be achieved without tilting by having the buffer conveyors B on the sides of the lift not at same height. In other words, the lift platform P is horizontally oriented and the opposing rack conveyors B are on different heights. FIG. 6A schematically shows control of the lift platform P of a lift 6 when performing transfer of load units T from the lift platform P to a buffer conveyor B on one side and vice versa on the other side, when the lift platform P must be lowered to the exchange level. In this case the lift platform P is horizontally oriented and on the side of exchange to the buffer conveyor B this buffer conveyor B is lower than that buffer conveyor B* on the other side.

As depicted, this allows the lift platform P to over travel beyond the transition level on the right-hand side allowing an early transfer to be initiated whilst first (i) being quickly generally coarsely positioned above the exchange level on the left-hand side by lowering the platform and the transfer to be initiated. Then (ii) the platform P can be exactly positioned slowly by creeping further downwards while the transfer is taking place and finalized. This saves time. The lifting platform may then creep up to the level such that the waterfall of both sides become equal for smoother transition.

FIG. 6B schematically shows control of the lift platform P of a lift 6 when performing transfer of load units T from the lift platform P to a buffer conveyor B* on one side and vice versa on the other side, when the lift platform P must be raised to the exchange level. In this case the lift platform P is horizontally oriented and on the side of exchange to the buffer conveyor B* this buffer conveyor B* is lower than that buffer conveyor * on the other side.

As depicted, this allows the lift platform P to over travel beyond the transition level on the left-hand side allowing an early transfer to be initiated whilst first (i) being quickly generally coarsely positioned above the exchange level on the right-hand side by raising the platform and the transfer to be initiated. Then (ii) the platform P can be exactly positioned slowly by creeping further upwards while the transfer is taking place and finalized. This saves time. The lifting platform may then creep down to the level such that the waterfall of both sides become equal for smoother transition.

1. A storage system comprising:
a multi-level storage rack;
a vertical lift connecting the levels of the multi-level storage rack, the vertical lift having a conveyor platform, with at least one rack level having a driven rack conveyor adjacent to the vertical lift; and
a controller configured for controlling the lift;
wherein the conveyor platform has a driven conveyor controlled by the controller to transfer loads to and from the conveyor platform and the rack conveyor such that the lift conveyor platform and rack conveyor are controlled to transfer a load between the lift conveyor platform and the rack conveyor or vice versa, and wherein the lift has a sensor arranged to determine a height positioning of the lift platform verses the rack level and coupled with the controller, wherein the transfer is controlled by the controller to be performed as soon as the lift conveyor platform and the rack conveyor are at same height based on height positioning from the sensor and the controller controlling the lifting platform to travel vertically beyond the rack level for transition thus allowing the transfer to be initiated by the controller earlier by transferring the load from the higher lift conveyor platform to the lower rack conveyor or vice versa by the controller controlling the driven conveyor of the conveyor platform and the conveyor adjacent to the vertical lift.

2. The storage system according to claim 1, wherein each storage level has a rack conveyor adjacent to the vertical lift controlled by the controller to function as a buffer decoupling the lift or to function as a supply and discharge conveyor for the storage rack.

3. The storage system according to claim 2, wherein the at least one rack level storage has a rack conveyor adjacent the vertical lift on each side functioning as a buffer.

4. The storage system according to claim 3, each storage level has a rack conveyor adjacent to the vertical lift on each side.

5. The storage system according to claim 4, wherein the controller is configured for controlling the lift, the driven conveyor of the conveyor platform and a drive of the driven rack conveyor such that the lift conveyor platform and conveyor are controlled to transfer a load between the lift conveyor platform and the rack conveyor or vice versa simultaneously.

6. The storage system according to claim 5, wherein the vertical lift conveyor platform is either statically tilted or dynamically tilted from a horizontal plane such that that one side can be over travelled while an opposite side is aligned with the opposing conveyor of the rack level for transition.

7. The storage system according to claim 1, wherein the vertical lift conveyor platform is horizontally oriented and the opposing rack conveyors are on different heights.

8. The storage system according to claim 1, wherein the system comprises at least two parallel racks with an aisle in between and a single level rack servicing vehicle running the length of the aisle between storage positions and the conveyor adjacent to the vertical lift.

9. The storage system according to claim 1, wherein the lift conveyor platform is controlled to move at a slower speed in an opposite direction to the initial vertical direction of movement to the rack level of transition after the over travel beyond the transition rack level.

10. (canceled)

11. A storage system comprising:
a multi-level storage rack;
a vertical lift connecting the levels of the multi-level storage rack, the vertical lift having a conveyor platform, with at least one rack level having a driven rack conveyor adjacent to the vertical lift; and
a controller configured for controlling the lift;
wherein the conveyor platform has a driven conveyor controlled by the controller to transfer loads to and from the conveyor platform and the rack conveyor such that the lift conveyor platform and rack conveyor are controlled to transfer a load between the lift conveyor platform and the rack conveyor or vice versa, and wherein the lift has a sensor arranged to determine a height positioning of the lift platform verses the rack level and coupled with the controller, wherein the transfer is controlled by the controller to be performed as soon as the lift conveyor platform and the rack conveyor are at same height based on height positioning from the sensor and the controller controlling the lifting platform to travel vertically beyond the rack level for transition thus allowing the transfer to be initiated by the controller earlier by transferring the load from the higher lift conveyor platform to the lower rack conveyor or vice versa by the controller controlling the driven conveyor of the conveyor platform and the conveyor adjacent to the vertical lift; and
wherein the at least one rack level storage has a rack conveyor adjacent the vertical lift on each side functioning as a buffer.

12. The storage system according to claim 11, wherein each storage level has a rack conveyor adjacent to the vertical lift on each side.

13. The storage system according to claim 11, wherein the controller is configured for controlling the lift, the driven conveyor of the conveyor platform and a drive of the driven rack conveyor such that the lift conveyor platform and conveyor are controlled to transfer a load between the lift conveyor platform and the rack conveyor or vice versa simultaneously.

14. The storage system according to claim 13, wherein the vertical lift conveyor platform is either statically tilted or dynamically tilted from a horizontal plane such that that one side can be over travelled while an opposite side is aligned with the opposing conveyor of the rack level for transition.

15. The storage system according to claim 11, wherein the vertical lift conveyor platform is horizontally oriented and the opposing rack conveyors are on different heights.

16. The storage system according to claim 11, wherein the system comprises at least two parallel racks with an aisle in between and a single level rack servicing vehicle running the length of the aisle between storage positions and the conveyor adjacent to the vertical lift.

17. The storage system according to claim 11, wherein the lift conveyor platform is controlled to move at a slower speed in an opposite direction to the initial vertical direction of movement to the rack level of transition after the over travel beyond the transition rack level.

18. A method for operation of a storage system according to claim 1, said method comprising:
controlling the lift conveyor platform and the rack conveyor to transfer a load between the lift conveyor platform and the rack conveyor or vice versa;
wherein the transfer is controlled to be performed as soon as the lift conveyor platform and the rack conveyor are at same height and lifting platform over travels beyond transition level allowing the transfer to be initiated earlier by transferring the load from the higher lift conveyor platform to the lower rack conveyor or vice versa.
